(19) United States
(12) Patent Application Publication
(10) Pub. No.: US 2005/0204290 A1
(43) Pub. Date: Sep. 15, 2005

(54) System and method for generating distributed application and distributed system topologies with management information in a networked environment

(76) Inventors: Brett P. Eddy, Poulsbo, WA (US); Kenneth Van Hyning, North Bend, WA (US); Karen D. Easterbrook, Duvall, WA (US); Ashvinkumar J. Sanghvi, Issaquah, WA (US); Barry McHugh, Dublin (IE); Stephen T. Kelly, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/799,443

(22) Filed: Mar. 12, 2004

(51) Int. Cl. G06F 9/00

(52) U.S. Cl. 715/733; 715/734; 715/735

(57) ABSTRACT

A system and method for generating computer network topological and management information in a graphical user interface are provided. A management computer obtains a request to generate application topological and management information for two or more sites within a computer network. The management computer obtains site attribute information and processes the information to generate topological and management information. The resulting information is stored and formatted for generation on a graphical user interface. The topological and management information may be updated.

### FIELD OF THE INVENTION

Generally described, the present invention relates to computer software and communication networks, and in particular, to a system and method for generating computer network site topological and management information in a graphical user interface.

### BACKGROUND OF THE INVENTION

Generally described, a computer communication network can include a number of interconnected computing devices. For organizational/management purposes, a grouping of a subset of the computing devices within the network can be considered a subnet, which can connected in some manner to other subnets within the same network. FIG. 1 is a block diagram illustrative of a computer network 100 including a number of networked subnets 102, 104, 106, 108, 120 and 122. Each subnet 102, 104, 106, 108, 120 and 122 can have a different number of networked computing devices. As illustrated in FIG. 1, a portion of the subnets 102, 104, 106 and 108 communicate with one another via a communication network, such as high speed local area network (“LAN”) connections 112, 114, 116, and 118, via router 110. Likewise, another portion of the subnets 120 and 122 communicate via a separate communication network, such as network connections 126 and 128, via router 124. Still further, subnets 102, 104, 106, 108 can communicate with subnets 120, 122 via a communication network, such as wide area network (“WAN”) connection 130.

Each of the subnets within the computer network 100 may also be associated with additional computing devices that maintain information common to each of the subnets. In one common embodiment, for example, the computer network 100 can include one or more distributed application servers that maintain and replicate information about the network. The distributed application servers can include directory servers, Microsoft Corporation's Active Directory directory servers, electronic mail servers, such as Microsoft Corporation's Exchange electronic mail servers, and any other server having a distributed application. FIG. 2 is a block diagram of the computer network 100 illustrating the inclusion of a number of distributed application servers for maintaining network information in accordance with the present invention. As illustrated in FIG. 2, the network 100 can include two distributed application servers 132, 134, such as a directory server and an electronic mail server, for subnets 102, 104, 106 and 108 and a single distributed application server 136, such as another directory server, for subnets 120, 122. The utilization of various distributed application servers 132, 134, 136 allow the various subnets to share user and network information in an efficient manner.

To facilitate management of the network as a whole, the various subnets within a network may be organized according to specific criteria. In one aspect, the subnets may be organized according to physical criteria, such as how the subnets are physically in communication with one another. In another aspect, the subnets may be organized according to logical criteria, such as by grouping subnets with similar functions/configurations. For example, subnets may be organized logically according to the speed of network connection, such that subnets connected via similar speed local network connections may be considered as a single object within the network for management purposes. The grouping of various subnets can be referred to a network site, or site. One skilled in the relevant art will appreciate that specific physical and logical criteria for grouping the subnets can vary according to the specific management goals/requirements.

FIG. 3 is a block diagram of the computer network 100 of FIG. 2 illustrating the grouping of subnets as sites within the computer network. As illustrated in FIG. 3, subnets 102, 104, 106, and 108 have been grouped together, such as because they share similar speed LAN connections, and are considered a single site 134 within the computer network 100. Additionally, subnets 120, 122 have been grouped together and are considered another site 136 on the computer network 100. In the illustrative example, sites 134 and 136 were not combined as a single site because of the likely slower speed connection provided by the wide area connection 130.

The collection of information from the resulting grouping of subnets as sites on the computer network 100 can be utilized by a user, such as a network administrator, to understand the organization of the network in the form of a network topology. For example, the network administrator can collect physical topology information from a directory server connected to the sites. Additionally, the grouping of the subsets can be further utilized to express various management information, such as how information flows between sites, various attributes about the sites, and/or the relative health/status of the interconnected sites on the computer network 100. With reference now to FIG. 4, a network site topology can be synthesized from the grouping information by representing each site as an object having any number of network connections and site attributes. As illustrated in FIG. 4, sites 134 and 136 (FIG. 3) are now represented as site objects 402 and 404. Additionally, the connection between the two sites 402, 404 is represented by connection object 406, which can define the attributes of the connection.

Although the utilization of distributed application servers within a network facilitates the tracking of various subnet, or site, attributes, the information maintained by information sources, such as the directory servers, cannot be readily processed to generate meaningful network topology and management information. For example, typical directory servers provide site interconnection information via a tree structure that lists the connections for each site. However, the tree structure approach does not visually represent the interrelationship between network sites. Thus, a user would have to review each site entry and manually track site interconnection. Additionally, site attribute information provided by multiple distributed application server sources, such as directory servers and mail servers, may not individually provide status/health properties of the connections between sites. For example, a mail server may provide physical mail routing information. However, a directory server would also be required to provide information flow direction from each site. Current management approaches do not provide an efficient manner to collect, process and represent the information in a meaningful manner to the user.

Thus, there is a need for a system and method for generating site topological and management information in a graphical user interface.

### SUMMARY OF THE INVENTION

A system and method for generating computer network topological and management information in a graphical user interface are provided. A management computer obtains a request to generate topological and management information for two or more sites within a computer network. The management computer obtains site attribute information and processes the information to generate topological and management information. The resulting information is stored and formatted for generation on a graphical user interface. The topological and management information may be updated.

In accordance with an aspect of the present invention, a method for generating topological and management information is provided. The method may be implemented in a computer system having a graphical user interface. In accordance with the method, a management computing system obtains a request to generate topological and management information corresponding to two or more sites associated with a network. The management computing system obtains obtaining site attribute information corresponding to the two or more sites and processes the site attribute information to obtain site topological and management information. The management computing device then generates the site topological and management information on the graphical user interface.

In accordance with another aspect of the present invention, a method for generating topological and management information is provided. The method may be implemented in a computer system having a graphical user interface. In accordance with the method, a management computing device obtains a request to generate topological and management information corresponding to a plurality of sites associated with a network. The management computing system generates site topological and management information based upon imported site attribute information. Additionally, the management computing system generates the site topological and management information on the graphical user interface.

In accordance with another aspect of the present invention, a method for generating topological and management information is provided. The method may be implemented in a computer system having a graphical user interface. In accordance with the method, a management computing device obtains a request to generate topological and management information corresponding to a plurality of sites associated with a network. The management computing device generates site topological and management information based upon site attribute information. Additionally, the management computing device generates the site topological and management information on the graphical user interface.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a computer network including a number of networked subnets in accordance with the present invention;

FIG. 2 is a block diagram of the computer network of FIG. 1 illustrating the inclusion of directory servers for maintaining network information in accordance with the present invention;

FIG. 3 is a block diagram of the computer network of FIG. 2 illustrating the grouping of subnets as sites within the computer network;

FIG. 4 is a block diagram of a network topological corresponding to the site grouping of FIG. 3 in accordance with the present invention;

FIG. 5 is a flow diagram illustrative of a network topological generation implemented by a management computing device in accordance with the present invention; and

FIGS. 6A-6C are block diagrams illustrative of a management computing device screen display for generating and updating the computer network topological in accordance with the present invention.

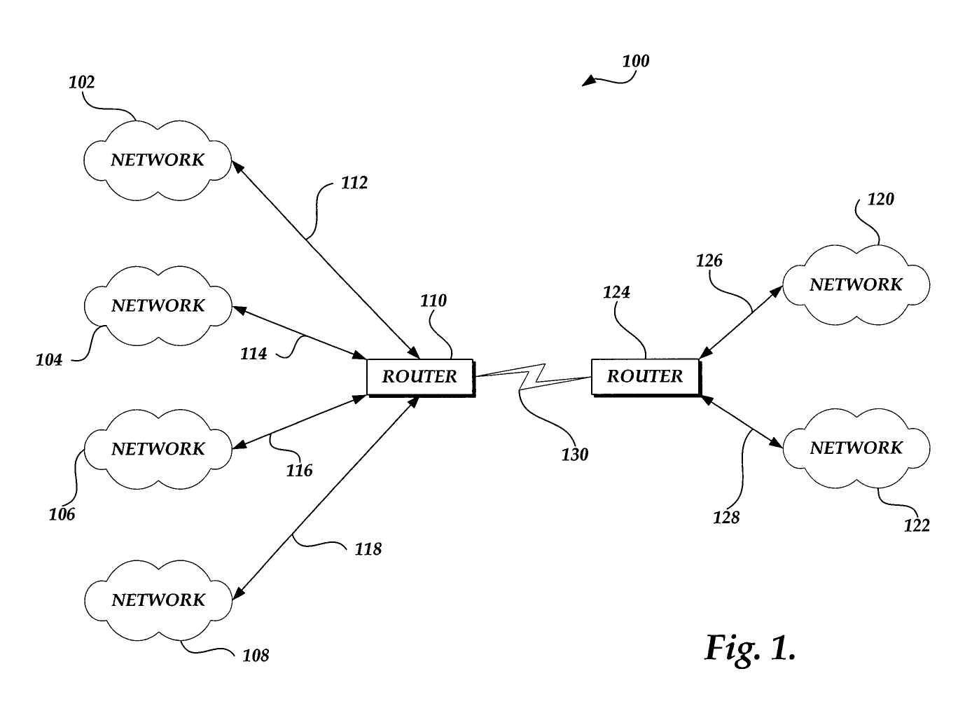

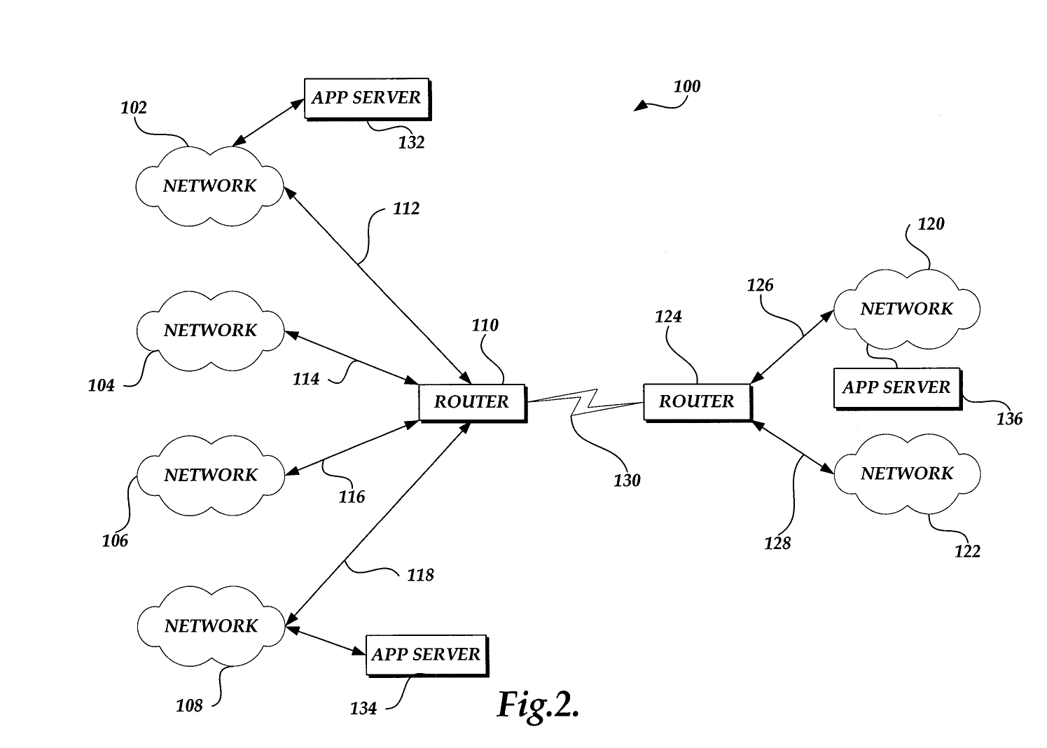

### DETAILED DESCRIPTION OF THE PREFERRED EMBODIMENT

Generally described, the present invention relates to a system and method for generating computer network topological and management information. More specifically, the present invention relates to a system and method for generating and maintaining computer network topological and management information in a graphical user interface. As will be described in greater detail below, the topological information can correspond to a representation of one or more subnets within the computer network 100 based on logical and/or physical organizational criteria. Further, the management information can correspond to one or more attributes of an identified network site, such as an assigned processing cost. The management information can also correspond to one or more processed attributes, such as health model rating, for an identified site. Further, the management information can correspond to information describing the interrelationship between two or more sites, such as the directional flow of communication between sites and an associated cost for the communication link. Although the present invention will be described in accordance with illustrative computer network attribute information providers and illustrative graphical user interfaces, one skilled in the relevant art will appreciate that the disclosed embodiments are illustrative in nature and should not be construed as limiting.

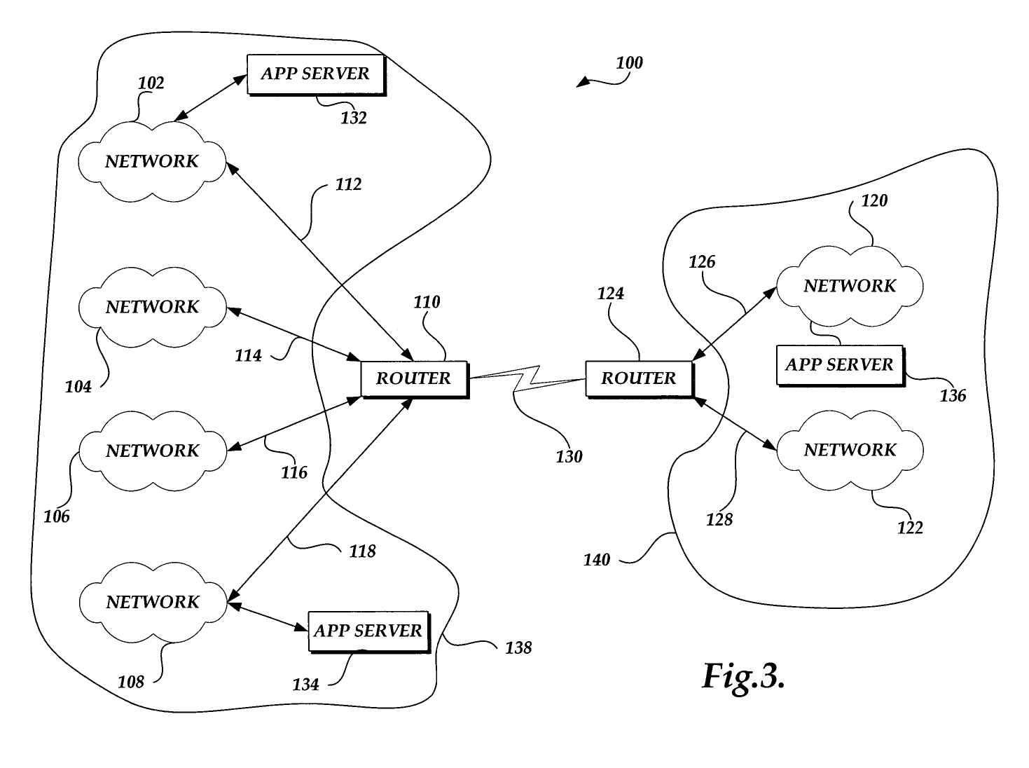

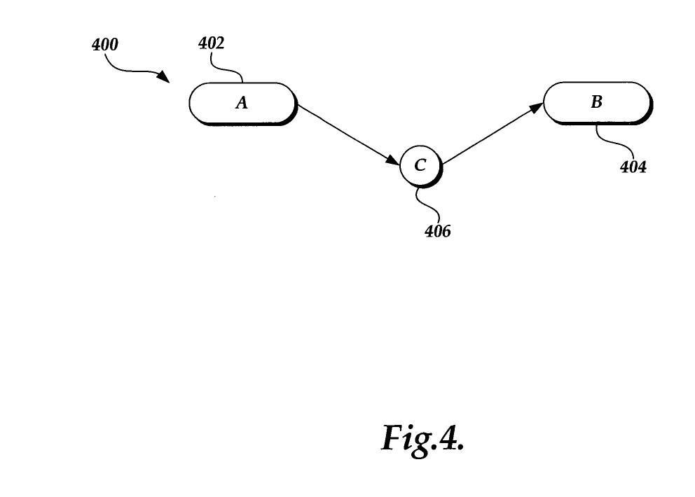

Referring again to FIG. 3, the present invention may be implemented in a network 100 includes a plurality of subnets 102, 104, 106, 108, 120 and 122 that are in communication with another. Various subnets may be further grouped into network sites 134, 136 that correspond to subnets having common network communication attributes, such as a LAN. Each site 134, 136 may be associated with one or more distributed application servers 132, 134 and 136, that provide information corresponding to the sites within the network 100 and/or users of the network. In an illustrative embodiment of the present invention, the distributed application servers can correspond to directory servers, mail servers, and any additional distributed application server that can identify a schema of a software application on a computing device and how it interactions with other computing devices. As illustrated in FIG. 3, the network 100 can include any number of distributed application servers.

In accordance with an illustrative embodiment of the present invention, one or more computing devices in the computer network 100 can include some type of software application for generating and managing topological and management information on a graphical user interface. In an illustrative embodiment of the present invention the computing devices can correspond to personal computers, server computers, hand-held computing devices, mobile communication devices, computing terminals, and the like. The software application can correspond to a stand alone software application for generating and managing the topological and management information. Additionally, the software application can correspond to one or more executable modules for utilization with general purpose software applications. For example, the one or more executable modules can be utilized in conjunction with a general purpose drawing and visualization software application.

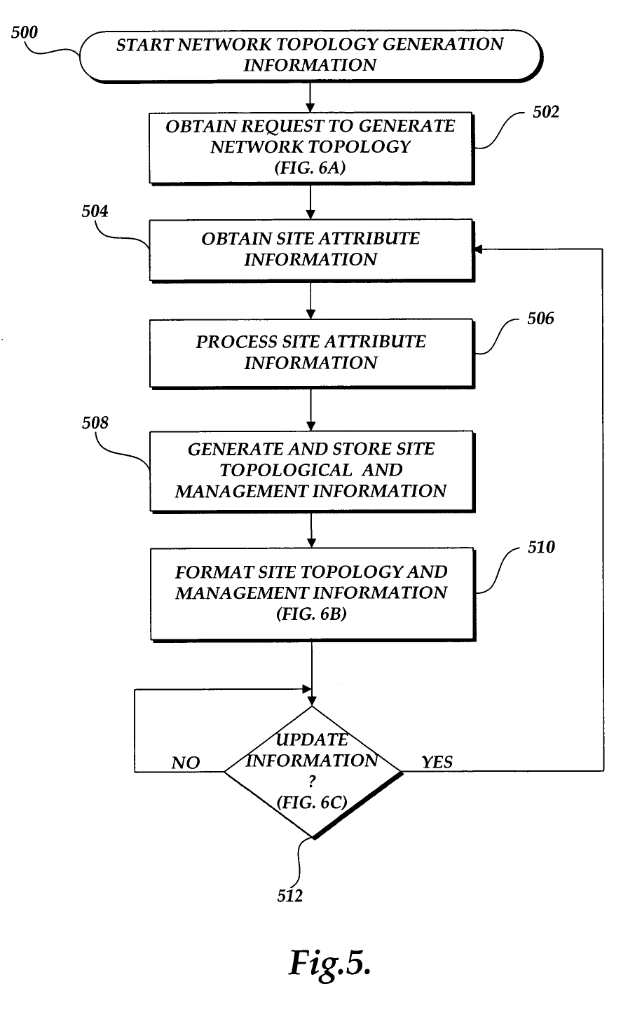

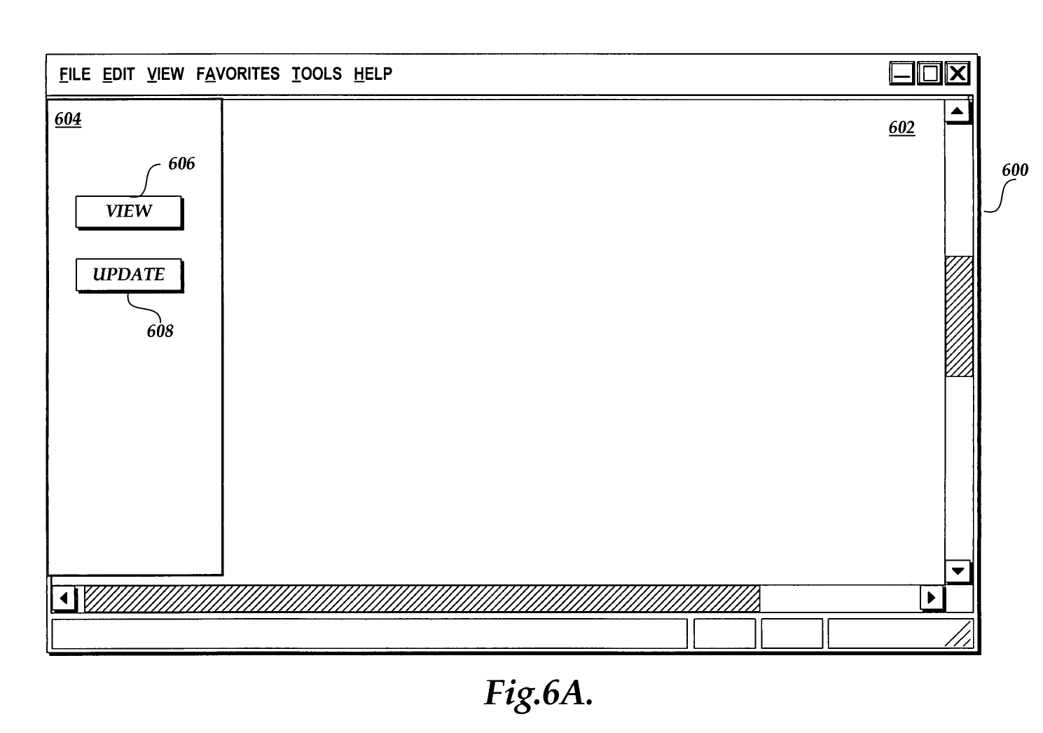

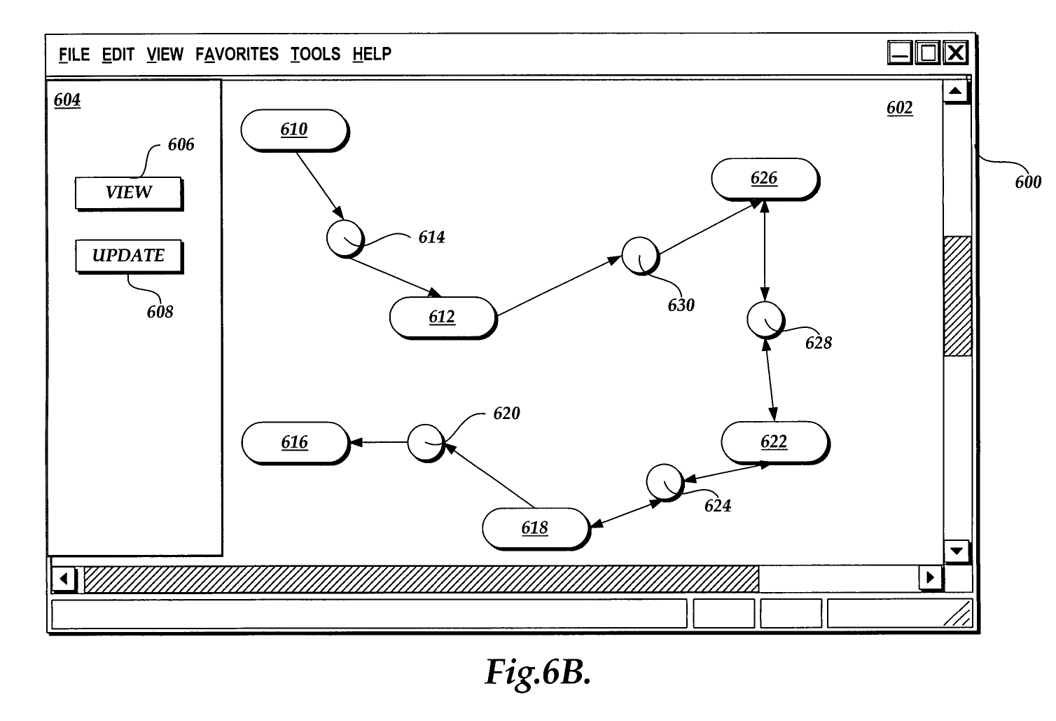

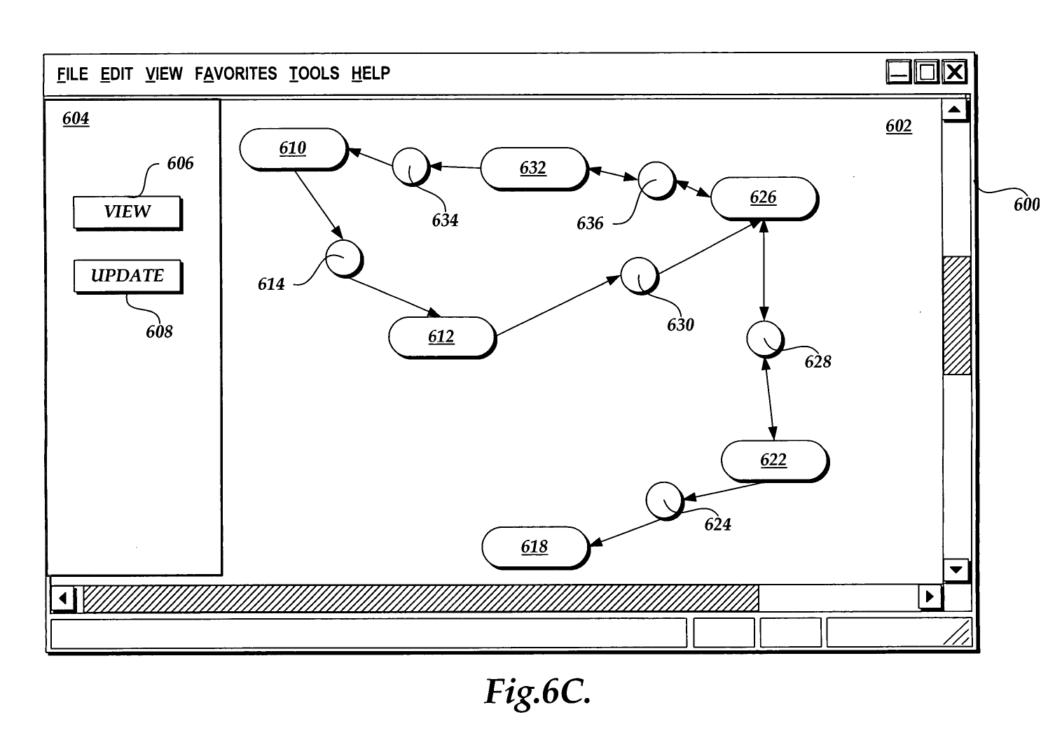

FIG. 5 is a flow diagram illustrative of a routine 500 implemented by a computing device for generating and manipulating topological and management information in accordance with the present invention. At block 502, the computing device obtains a request to generate network topological and management information. In an illustrative embodiment of the present invention, a user may be presented with a graphical user interface including one or more display objects. The display objects can correspond to software application controls that requests the generation of topological and management information. Additionally, the display objects can also include additional controls for manipulating, updating, and/or storing the topological and management information. FIG. 6A is a block diagram illustrative of a screen display 600 for generation topological and management information. In an illustrative embodiment of the present invention, the screen display 600 includes a first display portion 602 for generating topological and management information and a second display portion 604 for generating various user controls. As illustrated in FIG. 6A, the second display portion 604 includes a topological and management information generation control 606 and an update control 608.

Returning to FIG. 5, at block 504, the computing device obtains site attribute information. As illustrated in FIG. 3, the site attribute information is maintained and imported from one or more distributed application servers 132, 134 and/or 136 connected to the computer network. In an illustrative embodiment of the present invention, the site attribute information can include information identifying each of the sites that make up the computer network. Additionally, the site attribute information can also include site interconnection information identifying how the identified sites are connected to one another and an estimated cost for each of the interconnections. The site attribute information can also include additional information, such as a perceived status of the site, other site health model information, and a variety of underlying data/statistics that can be utilized to describe the site and/or its relationships. Still further, the site attribute information can correspond to a manifest/schema corresponding to the physical or logical organization of the subnets. In an illustrative embodiment of the present invention, the site attribute information may be imported as an XML data stream upon request. Alternatively, the site attribute information may be obtained as part of scheduled delivery of data.

At block 506, the computing device processes the imported site attribute information. In accordance with the present invention, the computing device may have to undertake additional processing steps to process the imported attribute information into topological and/or management information. In one aspect, the computing device may implement into an iterative algorithm to identify all sites with the network and to generate one or more connection objects for each site. The iterative algorithm can not only identify which display objects are connected, but also a directional flow for communications. Additionally, in an illustrative embodiment of the present invention, the imported attribute information may also include a schema/manifest defining a template as to how the topological information should be rendered on a graphical user interface. The schema/manifest may correspond to a network template requirement and/or a specific user requirement. In accordance with this embodiment, the physical attribute information would be further processed in accordance with the defined schema/manifest.

In another aspect, the computing device may implement a rules-based approach to determine a health model evaluation or other formulaic assessment for identified sites. In accordance with this aspect, the computing device obtains the underlying data from each site and applies a set of dynamic or static processing rules to determine an assessment of the site attribute information. For example, the management computing device may important a number of site attributes and then determine a site connection health model rating. The underlying data may correspond to site attribute data from one or more distributed application servers 132, 134, or 136 and/or additional information that may be relevant to the adopted health model. The resulting determination may be associated with the data and/or used to generate visual cues. Similar to the site topological information, in an illustrative embodiment of the present invention, the distributed application servers 132, 134, 136 may provide an identification of which processing rules to apply and/or submit additional processing rules as part of the information importation (block 504).

At block 508, the computing device generates and stores topological and management information corresponding to the processed site attribute information. In an illustrative embodiment to the present invention, the topological and management information may be embodied in an XML data stream that defines various topological and management information for an individual site, selected portions of the network, and/or the entire computer network 100. The XML data stream may be stored and recalled from a database. In another embodiment of the present invention, the topological and management information may correspond to associated entries in a relational database schema.

At block 510, the computing device formats the topological and management information for rendering. In an illustrative embodiment of the present invention, the software application can utilize general purpose visualization and drawing components to generate the topological and management information on the screen display 600. In accordance with this embodiment, the computing device may need to process the site topological and management information to the requirements of the selected general purpose visualization software application. However, one skilled in the relevant art will appreciate that the formatting step may be omitted altogether in the event that the visualization and drawing components do not require further formatting and/or in the event that the software application incorporates its own visualization and drawing tools.

FIG. 6B is a block diagram of the screen display 600 (FIG. 6A) illustrating the generation of topological and management information in accordance with the present invention. As illustrated in FIG. 6B, the first display portion includes a number of display objects that correspond to identifiable network sites and/or their properties. The screen display 600 includes nodes 610, 614, 616, 618, 622 and 626. Additionally, the screen display includes management information nodes 612, 620, 624, 628 and 630. As described above, the management information can include information identifying the cost of connection (in terms of speed) between two sites, status information of the site connection, and the like. Each site interconnect is represented by a line. Additionally, the topological information can also include directional property indicators, such as arrows or flow indicators for each site interconnection. Still further, in an illustrative embodiment of the present invention, the representations on the screen can include color indicators and/or additional display objects that provide additional visual indicators of the management information to a user. The site topological and/or management information can further include textual information that can be read/requested by the user to further explain the display objects, or attributes of the display objects.

Returning to FIG. 5, at decision block 512, a test is conducted to determine whether the topological and management information should be updated. In an illustrative embodiment of the present invention, an indication to update the topological and management information may be received through a user manipulation of an “update” control, such as control 608 (FIG. 6). Additionally, the topological and management information may also be updated a predetermined intervals and/or upon occurrence of some event. If the information should not be updated, the routine 500 returns to decision block 512. If the topological and management information should be updated, the routine 500 returns to block 504. FIG. 6C is a block diagram of the screen display 600 of FIG. 6B illustrating the updating of the information on the display portion 602. As illustrated in FIG. 6C, node 616 and its connection node 620 have been deleted. Additionally, node 632 has been added with two additional connection nodes 634 and 636. In an illustrative embodiment of the present invention, the management information, visual indicators, such as colors/icons, or other display object information may also be updated to reflect a current snapshot of the collected data.

While illustrative embodiments of the invention have been illustrated and described, it will be appreciated that various changes can be made therein without departing from the spirit and scope of the invention.

1. In a computer system having a graphical user interface, a method for generating topological and management information, the method comprising:
obtaining a request to generate application topological and management information corresponding to two or more sites associated with a network;
obtaining site attribute information corresponding to the two or more sites;
processing the site attribute information to obtain site application topological and management information; and
generating the site topological and management information on the graphical user interface.

2. The method as recited in claim 1, wherein obtaining a request to generate application topological and management information includes:
generating a display object on the graphical user interface, wherein the display object corresponds to a graphical control for initiating the generation of application topological and management information;
obtaining a user selection of the display object; and
generating the request to generate network information.

3. The method as recited in claim 1, wherein obtaining site attribute information corresponding to the two or more sites includes obtaining directory information identifying each of the two or more sites associated with the network.

4. The method as recited in claim 3, wherein processing the site attribute information to obtain site application topological and management information includes interactively identifying site connection information from the site attribute information for the two or more sites.

5. The method as recited in claim 3, wherein obtaining site attribute information corresponding to the two or more sites includes obtaining directory information identifying connection information for the two or more sites associated with the network.

6. The method as recited in claim 5, wherein obtaining site attribute information corresponding to the two or more sites includes obtaining cost information for the connection information, wherein the cost information corresponds an estimated cost for transmitting data between two connected sites.

7. The method as recited in claim 1, wherein obtaining site attribute information corresponding to the two or more sites includes obtaining health model information for the two or more sites.

8. The method as recited in claim 1, wherein processing the site attribute information to obtain site application topological and management information includes:
obtaining one or more health model processing rules associated with the two or more sites;
applying the site attribute information to the one or more health model processing rules; and
generating health model information for the two or more sites based on the application of the health model processing rules.

9. The method as recited in claim 1, wherein generating the site application topological and management information on the graphical user interface formatting the site topological and management information for display on a software application program.

10. The method as recited in claim 9, wherein formatting the site application topological and management information for display includes generating an XML data stream for rendering by the software application program.

11. The method as recited in claim 1 further comprising obtaining a request to update the site application topological and management information.

12. The method as recited in claim 11, wherein obtaining a request to update the site application topological and management information includes:
generating a second display object on the graphical user interface, wherein the second display object corresponds to a graphical control for updating the topological and management information;
obtaining a user selection of the second display object; and
generating the request to update the topological and management information.

13. A computer-readable medium having computer-executable instructions for performing the method recited in claim 1.

14. A computer system having a processor, a memory and an operating environment, the computer system for performing the method recited in claim 1.

15. In a computer system having a graphical user interface, a method for generating topological and management information, the method comprising:
obtaining a request to generate application topological and management information corresponding to a plurality of sites associated with a network;
generating site application topological and management information based upon imported site attribute information; and
generating the site application topological and management information on the graphical user interface.

16. The method as recited in claim 14, wherein obtaining a request to generate application topological and management information corresponding to the plurality of sites includes:
generating a display object on the graphical user interface, wherein the display object corresponds to a graphical control for initiating generation of topological and management information;
obtaining a user selection of the display object; and
generating the request to generate application topological and management information.

17. The method as recited in claim 15, wherein generating site application topological and management information based upon imported site attribute information includes obtaining directory information identifying each of the two or more sites associated with the network.

18. The method as recited in claim 17, wherein generating site application topological and management information based upon imported site attribute information includes obtaining cost information for the connection information, wherein the cost information corresponds to an estimated cost for transmitting data between two connected sites.

19. The method as recited in claim 17, wherein generating site application topological and management information based upon imported site attribute information includes:
obtaining one or more health model processing rules associated with the plurality of sites;
applying the site attribute information to the one or more health model processing rules; and
generating health model information for the plurality sites based on the application of the health model processing rules.

20. The method as recited in claim 17, wherein generating site application topological and management information based upon imported site attribute information includes interactively identifying site connection information from the site attribute information for the two or more sites.

21. The method as recited in claim 15, wherein generating the site application topological and management information on the graphical user interface includes formatting the site topological and management information for display on a software application program.

22. The method as recited in claim 21, wherein formatting the site application topological and management information for display includes generating an XML data stream for rendering by the software application program.

23. The method as recited in claim 15 further comprising obtaining a request to update the site application topological and management information.

24. The method as recited in claim 23, wherein obtaining a request to update the site application topological and management information includes:
generating a second display object on the graphical user interface, wherein the second display object corresponds to a graphical control for updating the topological and management information;
obtaining a user selection of the second display object; and
generating the request to update the site application topological and management information.

25. A computer-readable medium having computer-executable instructions for performing the method recited in claim 15.

26. A computer system having a processor, a memory and an operating environment, the computer system for performing the method recited in claim 15.

27. In a computer system having a graphical user interface, a method for generating application topological and management information, the method comprising:
obtaining a request to generate application topological and management information corresponding to a plurality of sites associated with a network;
generating site application topological and management information based upon site attribute information; and
generating the site topological and management information on the graphical user interface.

28. The method as recited in claim 27, wherein obtaining a request to generate application topological and management information corresponding to the plurality of sites includes:
generating a display object on the graphical user interface, wherein the display object corresponds to a graphical control for initiating generation of topological and management information;
obtaining a user selection of the display object; and
generating the request to generate application topological and management information.

29. The method as recited in claim 27, wherein generating site application topological and management information includes obtaining directory information identifying each of the two or more sites associated with the network.

30. The method as recited in claim 29, wherein generating site application topological and management information based upon imported site attribute information includes interactively identifying site connection information from the site attribute information for the two or more sites.

31. The method as recited in claim 27, wherein generating site application topological and management information includes obtaining cost information for the connection information, wherein the cost information corresponds an estimated cost for transmitting data between two connected sites.

32. The method as recited in claim 27, wherein generating site application topological and management information based upon imported site attribute information includes:
obtaining one or more health model processing rules associated with the plurality of sites;
applying the site attribute information to the one or more health model processing rules; and
generating health model information for the plurality of sites based on the application of the health model processing rules.

33. The method as recited in claim 27, wherein generating the site application topological and management information on the graphical user interface includes formatting the site topological and management information for display on a software application program.

34. The method as recited in claim 33, wherein formatting the site application topological and management information for display includes generating an XML data stream for rendering by the software application program.

35. The method as recited in claim 27 further comprising obtaining a request to update the site application topological and management information.

36. The method as recited in claim 35, wherein obtaining a request to update the site application topological and management information includes:
generating a second display object on the graphical user interface, wherein the second display object corresponds to a graphical control for updating the topological and management information;
obtaining a user selection of the second display object; and
generating the request to update the site application topological and management information.

37. A computer-readable medium having computer-executable instructions for performing the method recited in claim 27.

38. A computer system having a processor, a memory and an operating environment, the computer system for performing the method recited in claim 27.
